(19) United States
(12) Patent Application Publication
(10) Pub. No.: US 2008/0210796 A1
(43) Pub. Date: Sep. 4, 2008

(54) DOUBLE CHUTE FOOD PROCESSOR

(76) Inventor: STEVEN C. COZZOLINO, New York, NY (US)

Correspondence Address: Lawrence Cruz;Conair Corporation, One Cummings Point Road, STAMFORD, CT, 06902, US

(21) Appl. No.: 11/959,648

(22) Filed: Dec. 19, 2007

Related U.S. Application Data
(60) Provisional application No. 60/875,679, filed on Dec. 19, 2006.

(51) Int. Cl. B02C 18/00; B02C 18/12; B02C 18/06

(52) U.S. Cl. 241/282.1

(57) ABSTRACT

A food processor (100) includes a base (102), a receptacle (108) mountable to the base (102), a drive mechanism (104) mounted within the base (102), a food processing blade (126) disposed within the receptacle (108) and operatively coupled to the drive mechanism (104), a cover (112) for at least partially covering the receptacle (108) and a feed tube (114) depending from the cover (112). The feed tube (114) includes an internal septum wall (120) defining first and second food chutes (116, 118). The first and second food chutes (116, 118) have respective chute openings (116a, 118a) for receiving food substances for processing by the food processing blade (126). At least one plunger, possibly two plungers (122, 124), may be positionable in the first and second food chutes (116, 118) for facilitating advancement of the food substances. The chute openings (116a, 118a) of the first and second food chutes (116, 118) may have substantially similar internal dimensions or different internal dimensions. The feed tube (114) may define a third food chute (128) having a chute opening (128a). In this embodiment, the chute openings 128a, 130a, 132a of at least two of the first, second and third food chutes 128, 130, 132 may have substantially different internal dimensions.

### CROSS REFERENCE TO RELATED APPLICATIONS

This application claims the benefit of and priority to U.S. Provisional Patent Application Ser. No. 60/875,679, filed Dec. 19, 2007, the entire content of which is incorporated by reference herein.

### BACKGROUND

1. Field of the Disclosure

The present invention relates to food appliances and, more particularly, to electric food processors.

2. Description of Related Art

Electric food processors exist in various sizes and forms. A food processor may be used to prepare food by mixing, grinding, chopping, slicing, grating, shredding, or by a variety of other processing operations. A food processor typically includes a base housing an electric motor, a drive shaft driven by the motor, a bowl and a lid mounted to the bowl. A rotatably driven blade is mounted to the drive shaft to process the food product inside the bowl.

A limitation of existing food processor appliances is that they are confined to dedicated configurations of blade size and shape, bowl size and shape, and feed chute size and shape. Some are sold with interchangeable components, but, require storage space for these additional components, and, consequently, increase the overall expense of the appliance.

### SUMMARY

Accordingly, a food processor includes a base, a receptacle mountable to the base, a drive mechanism mounted within the base, a food processing blade disposed within the receptacle and operatively coupled to the drive mechanism, a cover for at least partially covering the receptacle and a feed tube depending from the cover. The feed tube includes an internal septum wall defining first and second food chutes. The first and second food chutes have respective chute openings for receiving food substances for processing by the food processing blade. At least one plunger, possibly two plungers, may be positionable in the first and second food chutes for facilitating advancement of the food substances. The chute openings of the first and second food chutes may have substantially similar internal dimensions or different internal dimensions. The feed tube may define a third food chute having a chute opening. In this embodiment, the chute openings of at least two of the first, second and third food chutes may have substantially different internal dimensions.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein:

FIG. 1 is a side plan view of a food processor in accordance with an embodiment of the present disclosure illustrating a feed tube with first and second food chutes;

FIG. 2 is a perspective view of the food processor of FIG. 1;

FIG. 3 is a rear plan view of the food processor;

FIG. 4 is a top plan view of the food processor;

FIG. 5 is another side plan view of the food processor; and

FIG. 6 is a top plan view illustrating a feed tube with three food chutes.

### DETAILED DESCRIPTION

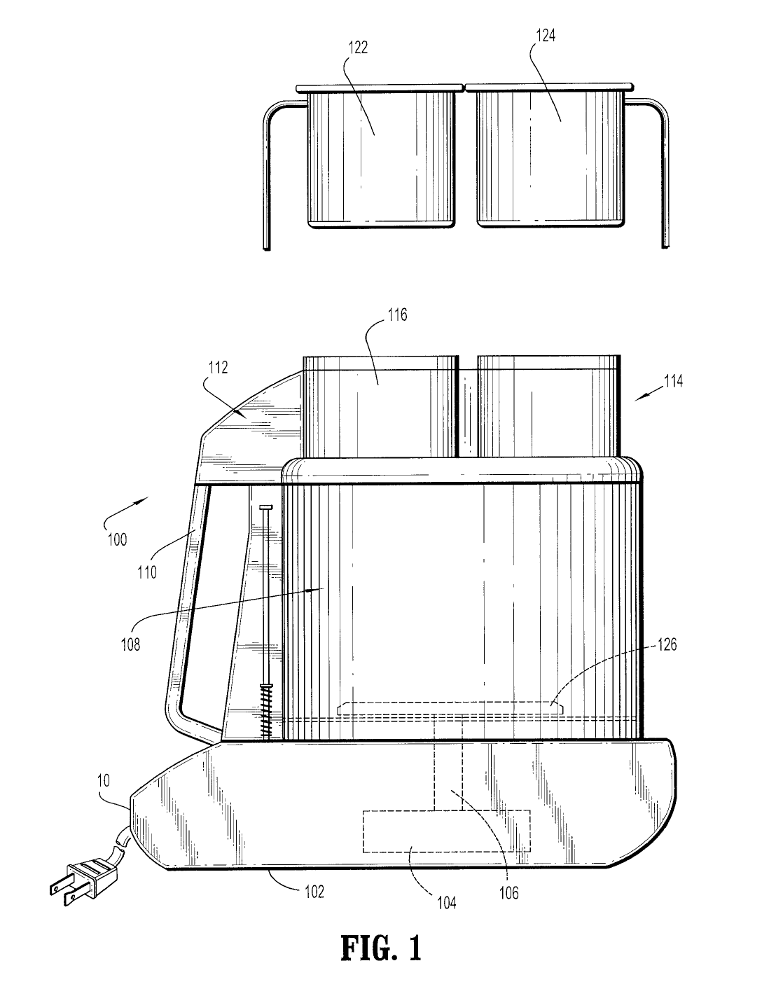

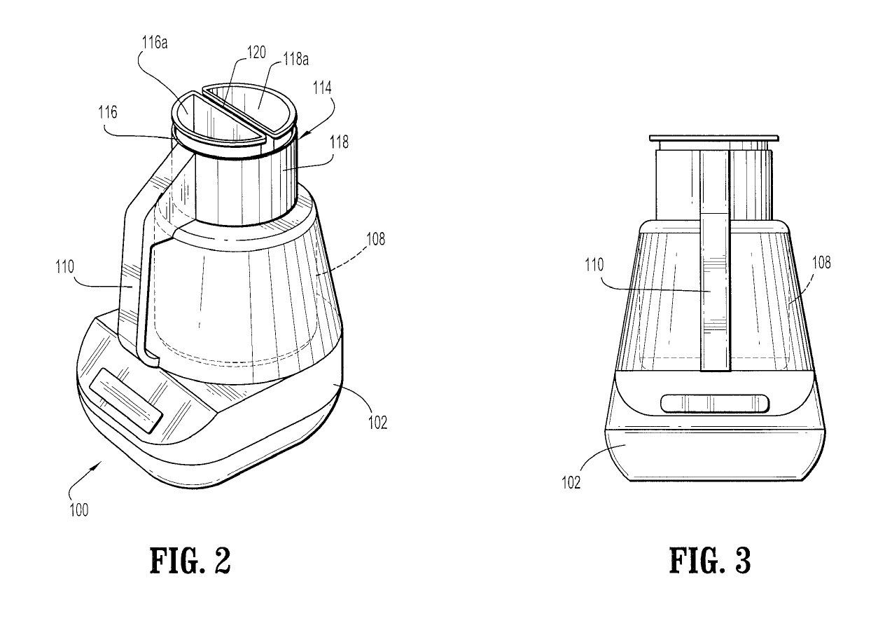

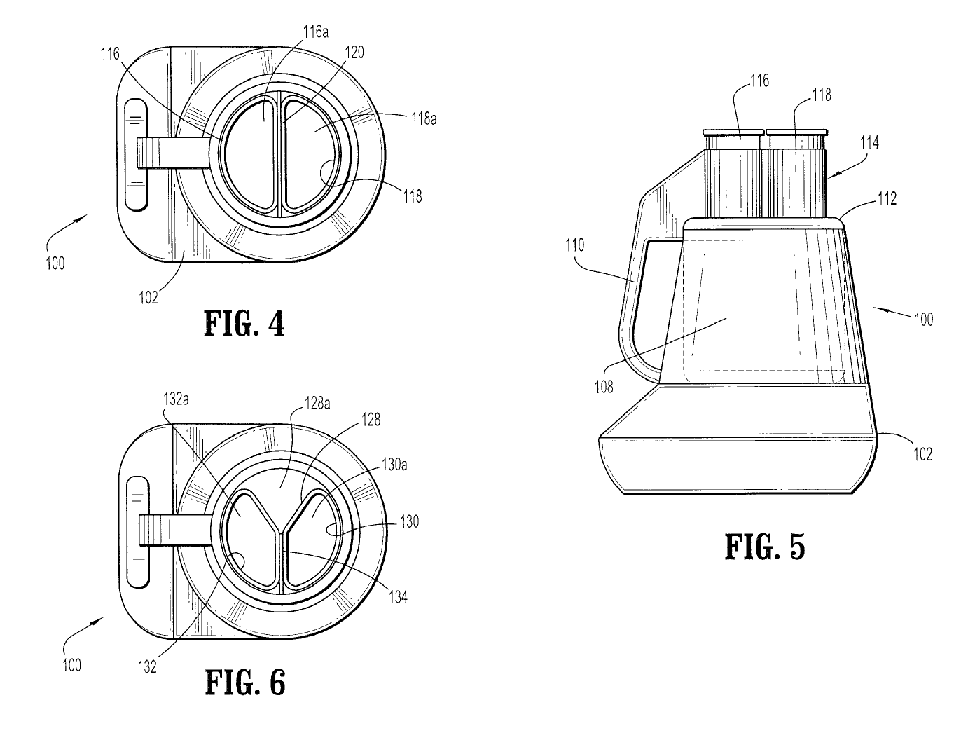

Referring now to the drawings wherein like reference numerals identify similar or like components throughout the several views, FIGS. 1-5 illustrate a food processor appliance 100 in accordance with the principals of the present disclosure. Food processor 100 includes base 102 which houses motor 104 (depicted schematically) and having drive shaft 106 extending from the base 102 and actuated by the motor 104. Motor 104 may be controlled and manipulated by a control panel which is mounted on the front of base 102 and is in communication with circuitry or logic within the base 102 to control functioning of food processor 100 as is known in the art. One suitable base is disclosed in commonly assigned U.S. Pat. No. 7,063,283 to Wanat or commonly assigned U.S. Pat. No. 7,069,839 to Kernan, the entire contents of each disclosure being incorporated herein by reference.

Food processor 100 further includes main receptacle or bowl 108 mounted to the top of the base 102. Main receptacle 108 may include handle 110 for engagement by the user and lid or cover 112. Cover 112 may be releasably mountable to base 102 through known means. Cover 112 includes feed tube 114 having first food chute 116 depending from the cover 112 and defining chute opening 116a for depositing of food substances. Feed tube 114 further includes second food chute 118 depending from the cover 112 and defining chute opening 118a also for depositing food substances. The presence of first and second chutes 116, 118 provides flexibility to the operator by, for example, permitting the depositing of a first food substance within the first chute 116 and a second food substance in the second chute 118. The second food substance may have a different texture, consistency, etc compared to the first food substance, which differences would otherwise inhibit handling and processing through the processor 100. Central openings 116a, 118a may be similar in size or internal dimension or, in the alternative, may have different dimensioning thereby providing additional flexibility to the operator when different size and/or texture food substances are being processed.

In one embodiment, first and second food chutes 116, 118 are integrally formed with feed tube 114. First and second chutes 116, 118 may be separated or isolated via septum wall or partition 120 extending the respective lengths of feed tube 114. In the alternative, first and second chutes 116, 118 may be interconnected or in communication with each other adjacent, for example, main receptacle 112 where a portion of septum wall 120 may be removed. In a further alternative, first and second chutes 114, 116 may be independent components separately mountable to cover 112.

Food processor 110 also contains at least one, possibly, two food plungers 122, 124. Food plungers 122, 124 may be identical in configuration as shown and, thus, may be positionable within either one of first and second food chutes 116, 118 to facilitate advancement of the food substances within the food chutes 116, 118. In the alternative, food plungers 122, 124 may have different sizes or cross-sections when central openings 116a, 118a possess different configurations.

Food processor 110 also includes blade 126 within main receptacle 108. Blade may be a disc blade or be adapted for chopping, dicing, slicing or the like blade.

FIG. 6 illustrates an alternate embodiment where feed tube 114 includes three food chutes 128,130,132. Food chute 128 defines chute opening 128a and food chutes 130, 132 define respective chute openings 130a, 132a. The dimensioning of chute opening 128a is different than the dimensioning of chute openings 130a, 132a to provide flexibility to the operator as discussed hereinabove. Feed tube includes a general y-shaped septum wall or partition 134 to form the three food chutes 128, 130, 132. A food plunger having a substantially similar cross-sectional dimension to that of food chute 128 may be provided to assist in feeding the food substances within chute opening 128a toward main receptacle 108. Similarly, at least one plunger with a cross-section corresponding to the dimensioning of food chutes 130, 132 may be provided.

Commonly assigned U.S. patent application entitled “Food Processor” under Attorney Docket No. 2200/P, filed on Dec. 19, 2006, U.S. provisional Ser. No. 60/875,680 herewith, and commonly assigned U.S. patent application entitled “Food Processor” under Attorney Docket No. 2201/p filed Dec. 19, 2006, U.S. Ser. No. 60/875,681 each disclose subject matter related to the present disclosure. The entire disclosures of each of these applications are hereby incorporated by reference herein.

Although the illustrative embodiments of the present disclosure have been described herein with reference to the accompanying drawings, it is to be understood that the disclosure is not limited to those precise embodiments, and that various other changes and modifications may be effected therein by one skilled in the art without departing from the scope or spirit of the disclosure.

What is claimed is:

1. A food processor, which comprises:
a base;
a receptacle mountable to the base;
a drive mechanism mounted within the base;
a food processing blade disposed within the receptacle and operatively coupled to the drive mechanism;
a cover for at least partially covering the receptacle;
a feed tube depending from the cover, the feed tube including an internal septum wall defining first and second food chutes, the first and second food chutes having respective chute openings for receiving food substances for processing by the food processing blade.

2. The food processor according to claim 1 including at least one plunger positionable in one of the first and second food chutes for facilitating advancement of the food substances.

3. The food processor according to claim 2 including two plungers.

4. The food processor according to claim 1 wherein the chute openings of the first and second food chutes have substantially similar internal dimensions.

5. The food processor according to claim 1 wherein the chute openings of the first and second food chutes have substantially different internal dimensions.

6. The food processor according to claim 1 wherein the feed tube defines a third food chute having a chute opening.

7. The food processor according to claim 6 wherein the chute openings of at least two of the first, second and third food chutes have substantially different internal dimensions.
